(19) United States
(12) Patent Application Publication
(10) Pub. No.: US 2026/0254474 A1
(43) Pub. Date: Aug. 27, 2026

(54) CAPACITIVE HYBRID FOR SIMULTANEOUS BI-DIRECTIONAL SIGNALING

(71) Applicant: NVIDIA Corp., Santa Clara, CA (US)

(72) Inventors: Yoshinori Nishi, San Jose, CA (US); John Poulton, Chapel Hill, NC (US); Xi Chen, Milpitas, CA (US)

(73) Assignee: NVIDIA Corp., Santa Clara, CA (US)

(21) Appl. No.: 19/544,829

(22) Filed: Feb. 19, 2026

Related U.S. Application Data
(60) Provisional application No. 63/763,051, filed on Feb. 25, 2025.

(51) Int. Cl. H04B 1/40

(52) U.S. Cl. CPC H04B 1/40

(57) ABSTRACT

Simultaneous bi-directional transceivers that include a main transmit driver, a replica transmit driver, and either a tri-capacitance network or a resistive-bi-capacitance network, wherein the replica transmit driver may be configured to receive an inverted form of a signal received by the main transmit driver, and a delay path for the main transmit driver may be configured to provide more precise tuning of signal delay than a delay path of the replica transmit driver.

### CROSS-REFERENCE TO RELATED APPLICATIONS

This application claims priority and benefit under 35 U.S.C. 119(e) to U.S. application Ser. No. 63/763,051, “Capacitive Hybrid for Simultaneous Bi-directional Signaling”, filed on Feb. 25, 2025, the contents of which are incorporated herein by reference in their entirety.

### BACKGROUND

Non-return to zero (NRZ) signaling is a binary communication mechanism used in digital systems and data storage. In NRZ signaling, the signal maintains a constant voltage level throughout the bit period rather than returning to a zero reference level between bits. NRZ signaling directly represents binary data with two distinct voltage levels: one for a binary ‘1’ and another for a binary ‘0’.

NRZ signaling may be implemented in two main variations. The first variation may be referred to as NRZ-Level (NRZ-L), wherein the binary signal level remains constant throughout the duration of particular bit. A high voltage represents one binary value (often ‘1’), and a low voltage represents the other binary value (‘0’).

The first variation may be referred to as NRZ-Inverted (NRZ-I), wherein a voltage transition occurs at the beginning of a bit if the bit is a ‘1’, and no transition occurs if the bit is a ‘0’, or vice versa. NRZ-I utilizes the occurrence of transitions, rather than absolute voltage levels, to convey information.

NRZ signaling is advantageous due to its simplicity and bandwidth efficiency. However, NRZ signaling may incur synchronization problems, especially with long sequences of identical bits, due to the unavailability of inherent clocking information.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a circuit architecture for a simultaneous bidirectional link.

FIG. 2 depicts a single-ended hybrid circuit in one embodiment.

FIG. 3A-FIG. 3E depict various embodiments of capacitively-coupled simultaneous bi-directional (SBD) transceiver circuits.

FIG. 4 depicts an SBD transceiver circuit in one embodiment.

FIG. 5 depicts a parallel processing unit in accordance with one embodiment.

FIG. 6 depicts a general processing cluster in accordance with one embodiment.

FIG. 7 depicts a memory partition unit in accordance with one embodiment.

FIG. 8 depicts a streaming multiprocessor in accordance with one embodiment.

FIG. 9 depicts a processing system in accordance with one embodiment.

FIG. 10 depicts an exemplary processing system in accordance with another embodiment.

FIG. 11 illustrates an exemplary data center 1100, in accordance with at least one embodiment.

### DETAILED DESCRIPTION

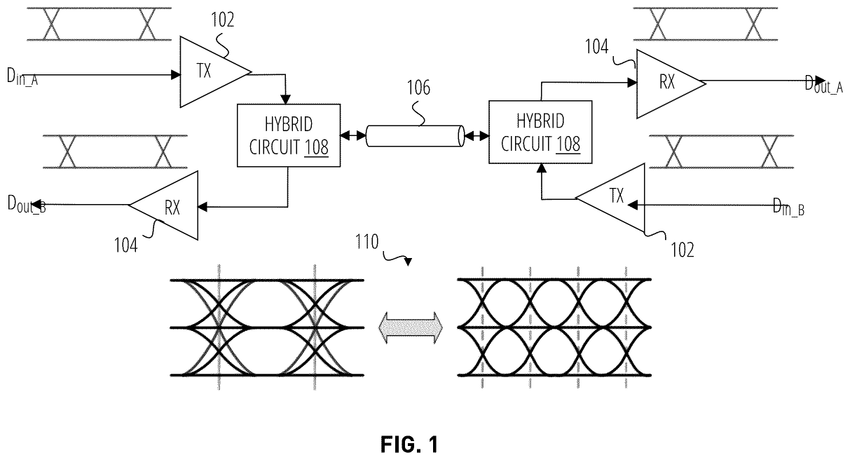

FIG. 1 depicts the structure of an SBD link. Transmitter 102 and receiver 104 stages at each end of the channel 106 are operated simultaneously. A hybrid circuit 108 stage is utilized to subtract outbound signals from inbound signals to recover signals at the receivers 104. There's no strict requirement that signaling frequencies in both directions be equal, although this is often the case. The eye diagrams 110 in FIG. 1 depict situations in which bi-directional signals at both ends of the channel 106 are synchronous and are 1) in-phase (left diagram), and 2) have a quadrate-phase relationship (right diagram).

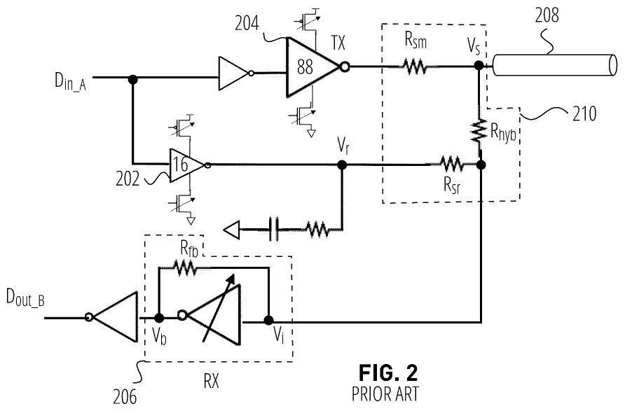

FIG. 2 depicts a single-ended hybrid circuit in one embodiment. With appropriate resistance ratios in the resistive network 210, the inbound signal is recovered at node (Vᵢ). The configuration of three impedance effects-a series impedance between the transmit driver 204 and the communication channel 208, a series impedance between the replica driver 202 and the trans-impedance amplifier 206, and a bridging impedance between the communication channel 208 and the trans-impedance amplifier 206, is referred to herein as an SSB resistive network 210 (series-series-bridged impedance network).

The trans-impedance amplifier 206 converts the current mode output from the resistive network 210 into a voltage signal, with amplification gain. The trans-impedance amplifier 206 may comprise a self-biased CMOS inverter that facilitates recovery of the received signal to CMOS levels without utilizing additional common mode voltage. In FIG. 2 and other drawings, values (88, 8, 24 . . . ) associated with the transmit drivers 204, replica drivers 202, and other components indicate exemplary driving strengths. The three resistances cooperate to cancel out a transmitted signal from a total signal that includes a received signal, leaving a remainder comprising the received signal for amplification.

Resistively-coupled circuits such as those depicted in FIG. 2 may consume a significant amount of static current because Vₛ and Vᵣ are at opposite polarities to subtract the outbound signal from the inbound signal to yield Vᵢ. Both ends of the line are DC-coupled to resistor networks that both consume current when the two ends of the line drive signals of opposite polarity. If one transmitter transmits high polarity signals and the other transmitter transmits low polarity signals, static current is consumed even if there are no transitions on the signals.

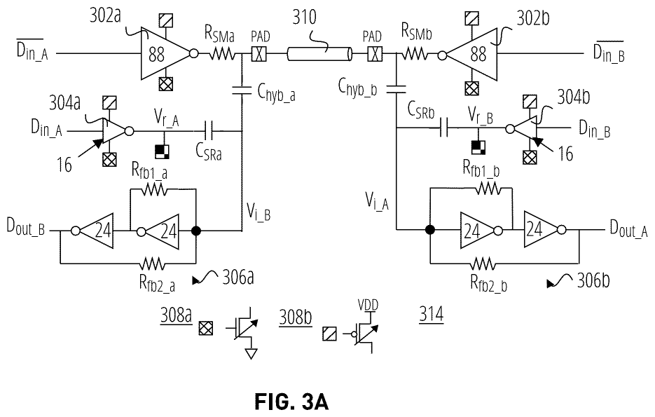

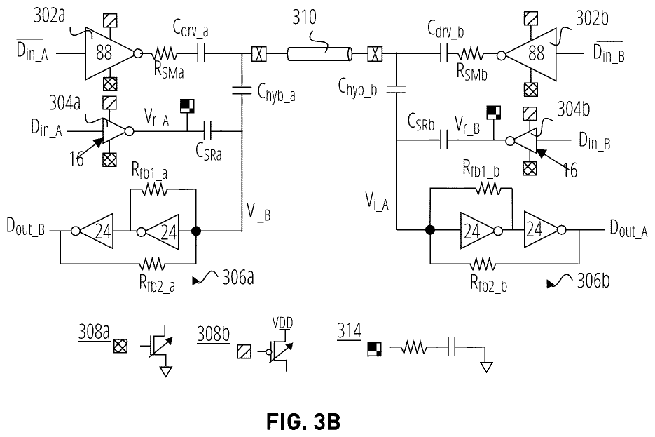

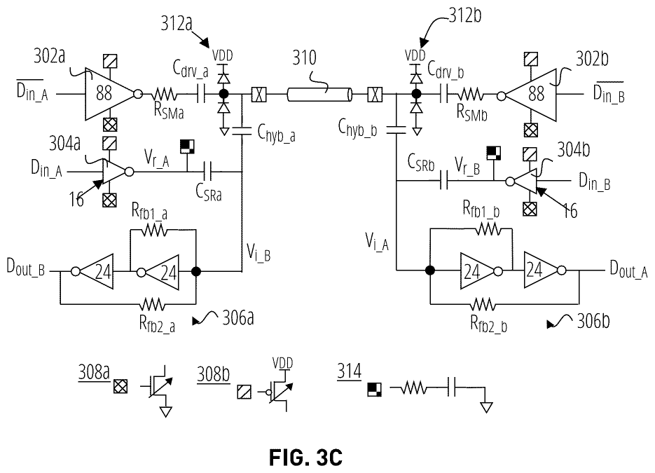

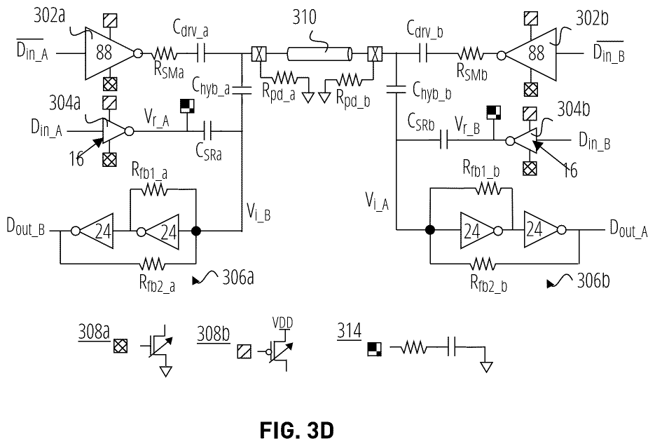

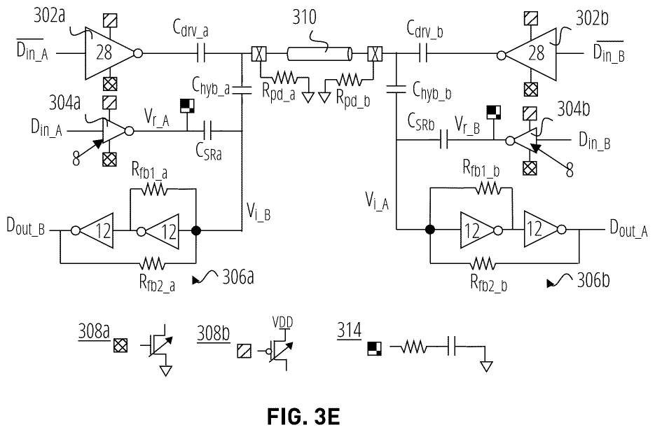

FIG. 3A-FIG. 3C depict exemplary embodiments of SBD signaling circuits utilizing capacitive signal summing instead of resistive signal summing. These circuits may mitigate the static current consumption of resistively coupled interfaces. In these embodiments, capacitive summing circuits cancel the outbound signal from the incoming data signal.

A number of mechanisms may be utilized to recover the “edge signals” formed by capacitive coupling to the original NRZ. For example, Vi_B may be biased to Vref with Vref applied to a differential sampler to sample incoming data with a clock. Another implementation may utilize positive feedback to toggle between bi-stable DC operating points based on the inputted edge signal, e.g., using a pair of inverters and a pair of resistors as depicted. However, other possible implementations will be readily apparent to those of skill in the art.

In some embodiments, a finite high-pass time-constant induced by capacitive coupling is compensated for by a positive feedback network that restores low frequency components.

Each embodiments comprises (main) transmit drivers 302a, 302b, replica drivers 304a, 304b, and receivers 306a, 306b each labeled with exemplary size/strength values. The common mode may be tuned to a particular implementation with trimming transistors 308a, 308b. The receivers 306a, 306b comprise amplifiers (FIG. 3A-FIG. 3E), one or more of which may comprise a trans-impedance amplifier.

The specific configuration of three capacitors depicted in FIG. 3B-FIG. 3E—a series capacitance C_{drv} between the transmit drivers 302a, 302b and the link 310, a series capacitance C_{SR} between the replica drivers 304a, 304b and the receivers 104, and a bridging capacitance C_{hyb} between the link 310 and the receivers 104, is referred to herein as a tri-capacitance network.

The specific configuration of a resistor and three capacitors depicted in FIG. 3A-FIG. 3E—a series resistance R_{SM} between the transmit drivers 302a, 302b and the link 310, a series capacitance C_{SR} between the replica drivers 304a, 304b and the receivers 104, and a bridging capacitance C_{hyb} between the link 310 and the receivers 104, is referred to herein as a resistive-bi-capacitance network.

Capacitive hybrid circuits in accordance with these embodiments may be applied to both DC-coupled drivers (FIG. 3A) and AC-coupled drivers (FIG. 3B-FIG. 3E) and may be particularly advantageous for use with AC-coupled interfaces to accommodate low frequency components in the data signals.

Conventional AC-coupled drivers may be constrained by the short time constant of their high-pass filter, and may require an external capacitor as large as a micro farad. The disclosed circuits may enable the utilization of high-pass filters with time constants on the order of a few nano seconds. The AC-coupling capacitance of the drivers may in some cases be reduced from a micro farad to substantially below a nano farad. The resulting savings in circuit area enable use of the disclosed circuits in area-constrained applications such as die-to-die links.

In addition to improvements in circuit area and power consumption, the disclosed SBD mechanisms may effectively set the single-ended receiver detection threshold to the mid-rail voltage of the receivers 306a, 306b. The two ends of an SBD link need not be operated on the same power supply voltage, since the operating bias condition of the receivers is substantially unaffected by the transmitters on the opposite ends of the link 310. Two circuits communicating on a link utilizing the disclosed mechanisms may therefore be implemented on different semiconductor technology nodes (e.g., device fabrication scales), which may be useful for certain applications, e.g., those systems employing optical or advanced electrical communication via specialized chips.

One exemplary use case for the disclosed circuits is with links between graphics processing units (GPUs) and central processing units (CPUs) from different vendors that may be implemented on different semiconductor technology nodes. Another exemplary use case is on chips that utilize dynamic voltage scaling for core circuits as well as input/output circuits, with operating voltages that vary with process differences, supply variation, and temperature.

Static current consumption at the link interfaces may be mitigated by utilizing capacitors C_{hyb} and C_{SR} where conventionally R_{hyb} and R_{SR} were disposed in the circuit. The positive feedback resistor R_{fb} mitigates voltage droop for long sequences of consecutive identical bits while enabling C_{hyb} and C_{SR} to remain relatively small. NRZ data values may thereby be effectively recovered.

The values of both feedback resistors R_{fb1} and R_{fb2} may be configured such that the voltage Vᵢ does not droop substantially toward the mid-range voltage between VDD and ground. The capacitances C_{hyb} and C_{SR} may be varied along with these resistive values to maintain a desired performance level.

Addition of the series capacitor C_{drv} at the output of the transmit drivers 302a, 302b impedes DC signals from propagating over the link 310 while enabling AC signals to pass unimpeded. In some applications the capacitance C_{drv} may be set in the microfarad range for broad-band impedance matching. For implementations in which the link 310 is as short as a few millimeters, such as die-to-die interfaces, impedance mismatches at frequencies much (e.g., at least an order of magnitude) lower than the nominal link frequencies may be disregarded. Therefor a smaller capacitance of several picofarads may be utilized in such scenarios.

The link 310 may be terminated at voltage levels suitable to different applications due to the AC coupling provided by C_{hyb}. The capacitance C_{drv} may for example be set to 10 pF, adding minimal line impedance at 12.5GHz. The termination resistors R_{pd} may be set for example to 50 KΩ to prevent the link 310 from floating.

The resistance of R_{pd} may be varied over a wide range provided the time constant of the link 310 (tₗᵢₙₑ~R_{pd}/2*(2*C_{drv}+Cₗᵢₙₑ)) remains much larger (at least on order of magnitude) than the time constant of the positive feedback loop (t_{fb}~R_{fb}*(C_{hyb}+C_{SR})). Here Cₗᵢₙₑ represents the inherent capacitance of the channel 106.

Leveraging this feature may enable further reductions in C_{drv} (e.g., ~1 pf) to enable even more compact designs. For implementations in which the length of the link 310 is in the range of a few millimeters, impedance mismatching due to C_{drv} may have insubstantial impact on performance, and a smaller C_{drv} capacitance may be utilized. Any resulting voltage droop may not affect performance of the receivers 306a, 306b provided that tₗᵢₙₑ exceeds t_{fb} by at least an order of magnitude. A commensurate adjustment to the capacitances C_{SR} may be made to maintain receiver performance in the nominal frequency band. Relatively substantial voltage droops at the pads may be tolerated provided that the extracted signal voltage Vᵢ remains stable.

The termination impedance R_{pd} and the termination voltage it determines may be varied over a wide range, with the constraint that tₗᵢₙₑ>>t_{fb}. In one embodiment, the termination impedance R_{pd} is provided by the leakage current through an electrostatic discharge (ESD) protection circuit 312a, 312b configured to protect the capacitors C_{hyb} and C_{SR}. The transmit drivers 302a, 302b and receiver drivers may in one embodiment be implemented using core MOSFETs.

A further reduction of power consumption may be achieved for short-range (e.g., a few millimeters) links 310. Due to the low round-trip delay of such short data lines, an even smaller C_{drv} may be utilized despite the higher impedance and increased signal reflection it induces. Removing the series resistance R_{SM} may mitigate the increased impedance. A smaller C_{drv} device, e.g., on the order of a fraction of a picofarad, may achieve reasonable performance, along with smaller driver devices.

The embodiments of FIG. 3A may be implemented with or without RC shunt 314 circuits (as depicted in FIG. 3B-FIG. 3E). Exemplary values for the resistive and capacitive components in these embodiments for SBD bandwidths of D_{in_A}=25.2 G and D_{in_B}=24.8 G are R_{SM}=22 Ω, C_{hyb}=30 fF and C_{SR}=16 fF for a 1.2 mm length of the link 310. Resistors R_{fb1} and R_{fb2} may for example be set to 3.5 kΩ and 3 KΩ, respectively.

Exemplary values for the resistive and capacitive components of the embodiment of FIG. 3B for D_{in_A}=25.2 G and D_{in_B}=24.8 G are R_{SM}=22 Ω, C_{drv}=10 pF, C_{hyb}=30 fF and C_{SR}=16 fF for a 1.2 mm length of the link 310. Resistors R_{fb1} and R_{fb2} may for example be set to 3.5 kΩ and 3 KΩ, respectively.

Exemplary values for the resistive and capacitive components of the embodiment of FIG. 3C and FIG. 3D for D_{in_A}=25.2 G and D_{in_B}=24.8 G are R_{SM}=22 Ω, C_{drv}=1 pF, C_{hyb}=30 fF and C_{SR}=13 fF for a 1.2 mm length of the link 310. Resistors R_{fb1} and R_{fb2} may for example be set to 3.5 kΩ and 3 KΩ, respectively.

Exemplary values for the resistive and capacitive components of the embodiment of FIG. 3E for D_{in_A}=25.2 G and D_{in_B}=24.8 G are C_{drv}=0.2 pF, C_{hyb}=30 fF and C_{SR}=7 fF for a 1.2 mm length of the link 310. Resistors R_{fb1} and R_{fb2} may for example be set to 15 kΩ and 15 KΩ, respectively.

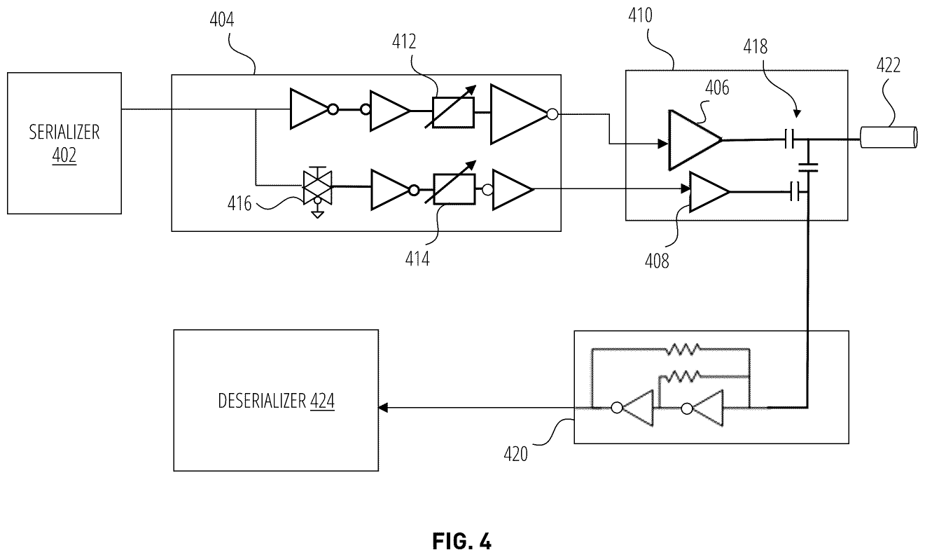

FIG. 4 depicts an SBD transceiver circuit in one embodiment. A serializer 402 receives a multi-bit input signal in parallel and converts it to serialized format to a pre-driver stage 404. The pre-driver stage 404 sets the relative timing of the serialized signal along a main path to the main transmit driver 406 and a replica path to the replica driver 408 in the driver and hybrid stage 410. The pre-driver stage 404 utilizes a configurable delay 412 on the main path and another configurable delay 414 on the replica path for this purpose. The pre-driver stage 404 also utilizes various drivers for buffering and other purposes known in the art. A pass gate 416 is disposed along the duplicate path to introduce non-inverting delay approximately equal to the first inverter in the upper path of the pre-driver stage 404.

Alternatively, a pair of low-fanout inverters may replace the pass gate 416, such that their combined delay is matched to the delay of a single inverter in the path to the configurable delay 412.

The tri-capacitance network 418 (which could instead be a resistive-bi-capacitance network) performs the hybrid operations described previously. At the input of the DC-restoring receiver front end 420, the tri-capacitance network 418 distinguishes signals received from the communication channel 422 from signals being simultaneously transmitted. These signals pass the DC-restoring receiver front end 420 and are converted from serial to parallel form by the deserializer 424. In the depicted embodiment, the DC-restoring receiver front end 420 comprises a pair of inverters configured as a bi-stable positive feedback circuit.

The DC-restoring receiver front end 420 may in alternate embodiments comprise clocked samplers to sample edge signals and hold the polarity of the signal as long as the clock duration.

The mechanisms disclosed herein may be implemented at link interfaces in computing systems utilizing one or more graphic processing unit (GPU) and/or general purpose data processor (e.g., a “central processing unit” or CPU). A graphics processing unit may be a standalone chip or package, or may comprise graphics processing circuitry integrated with a central processing unit. Exemplary architectures will now be described that may be configured with the SBD link interface mechanisms disclosed herein, e.g., interconnect 502, NVLink 504.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

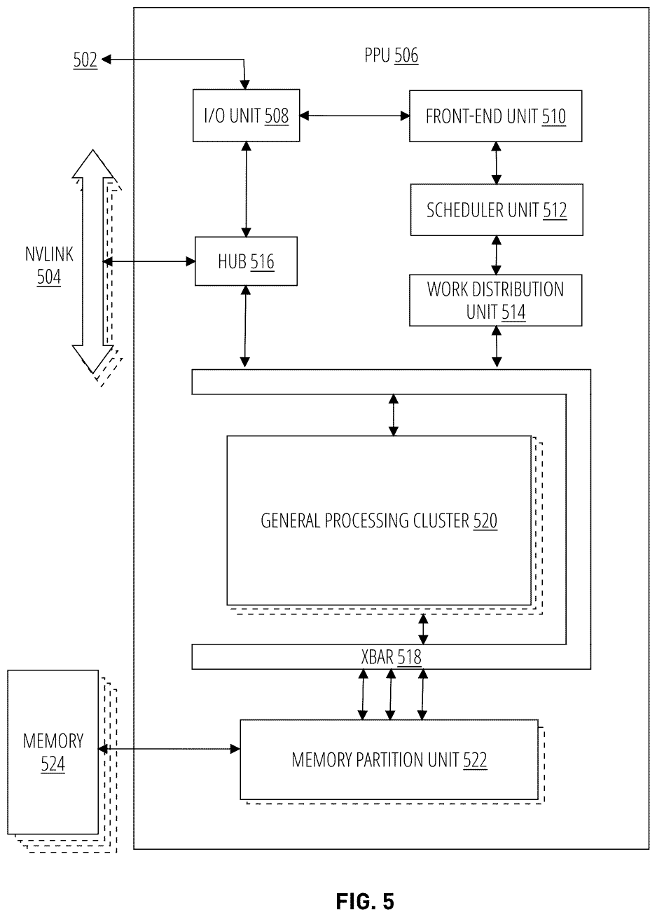

FIG. 5 depicts a parallel processing unit 506, in accordance with an embodiment. In an embodiment, the parallel processing unit 506 is a multi-threaded processor that is implemented on one or more integrated circuit devices. The parallel processing unit 506 is a latency hiding architecture designed to process many threads in parallel. A thread (e.g., a thread of execution) is an instantiation of a set of instructions configured to be executed by the parallel processing unit 506. In an embodiment, the parallel processing unit 506 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 506 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 506 modules may be configured to accelerate thousands of High Performance Computing (HPC), data center, and machine learning applications. The parallel processing unit 506 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the parallel processing unit 506 includes an I/O unit 508, a front-end unit 510, a scheduler unit 512, a work distribution unit 514, a hub 516, a crossbar 518, one or more general processing cluster 520 modules, and one or more memory partition unit 522 modules. The parallel processing unit 506 may be connected to a host processor or other parallel processing unit 506 modules via one or more high-speed NVLink 504 interconnects. The parallel processing unit 506 may be connected to a host processor or other peripheral devices via an interconnect 502. The parallel processing unit 506 may also be connected to a local memory comprising a number of memory 524 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 524 may comprise logic to configure the parallel processing unit 506 to carry out aspects of the techniques disclosed herein.

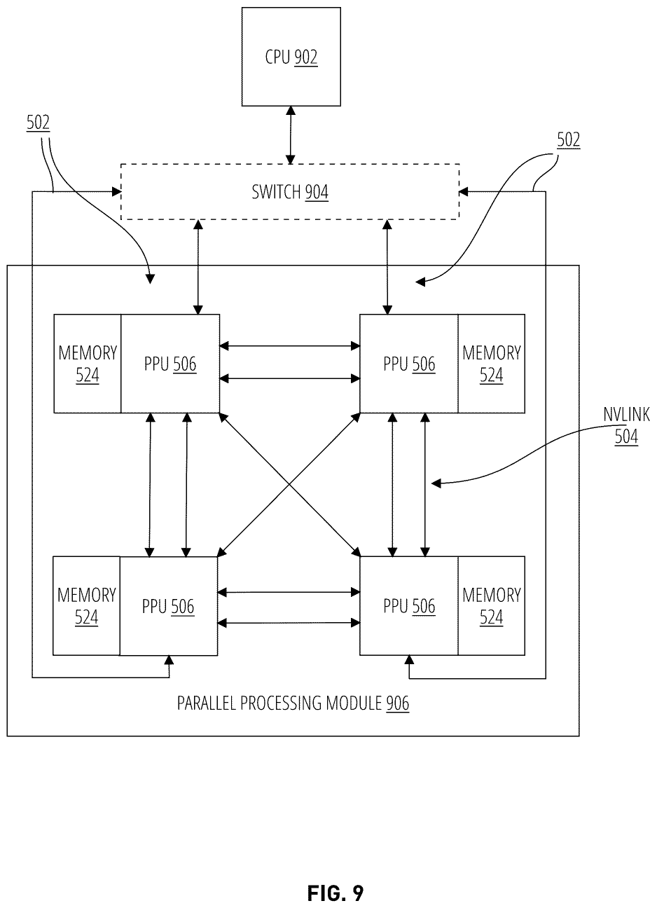

The NVLink 504 interconnect enables systems to scale and include one or more parallel processing unit 506 modules combined with one or more CPUs, supports cache coherence between the parallel processing unit 506 modules and CPUs, and CPU mastering. Data and/or commands may be transmitted by the NVLink 504 through the hub 516 to/from other units of the parallel processing unit 506 such as one or more copy engines, a video encoder, a video decoder, a power management unit, etc. (not explicitly shown). The NVLink 504 is described in more detail in conjunction with FIG. 9.

The I/O unit 508 is configured to transmit and receive communications (e.g., commands, data, etc.) from a host processor (not shown) over the interconnect 502. The I/O unit 508 may communicate with the host processor directly via the interconnect 502 or through one or more intermediate devices such as a memory bridge. In an embodiment, the I/O unit 508 may communicate with one or more other processors, such as one or more parallel processing unit 506 modules via the interconnect 502. In an embodiment, the I/O unit 508 implements a Peripheral Component Interconnect Express (PCIe) interface for communications over a PCIe bus and the interconnect 502 is a PCIe bus. In alternative embodiments, the I/O unit 508 may implement other types of well-known interfaces for communicating with external devices.

The I/O unit 508 decodes packets received via the interconnect 502. In an embodiment, the packets represent commands configured to cause the parallel processing unit 506 to perform various operations. The I/O unit 508 transmits the decoded commands to various other units of the parallel processing unit 506 as the commands may specify. For example, some commands may be transmitted to the front-end unit 510. Other commands may be transmitted to the hub 516 or other units of the parallel processing unit 506 such as one or more copy engines, a video encoder, a video decoder, a power management unit, etc. (not explicitly shown). In other words, the I/O unit 508 is configured to route communications between and among the various logical units of the parallel processing unit 506.

In an embodiment, a program executed by the host processor encodes a command stream in a buffer that provides workloads to the parallel processing unit 506 for processing. A workload may comprise several instructions and data to be processed by those instructions. The buffer is a region in a memory that is accessible (e.g., read/write) by both the host processor and the parallel processing unit 506. For example, the I/O unit 508 may be configured to access the buffer in a system memory connected to the interconnect 502 via memory requests transmitted over the interconnect 502. In an embodiment, the host processor writes the command stream to the buffer and then transmits a pointer to the start of the command stream to the parallel processing unit 506. The front-end unit 510 receives pointers to one or more command streams. The front-end unit 510 manages the one or more streams, reading commands from the streams and forwarding commands to the various units of the parallel processing unit 506.

The front-end unit 510 is coupled to a scheduler unit 512 that configures the various general processing cluster 520 modules to process tasks defined by the one or more streams. The scheduler unit 512 is configured to track state information related to the various tasks managed by the scheduler unit 512. The state may indicate which general processing cluster 520 a task is assigned to, whether the task is active or inactive, a priority level associated with the task, and so forth. The scheduler unit 512 manages the execution of a plurality of tasks on the one or more general processing cluster 520 modules.

The scheduler unit 512 is coupled to a work distribution unit 514 that is configured to dispatch tasks for execution on the general processing cluster 520 modules. The work distribution unit 514 may track a number of scheduled tasks received from the scheduler unit 512. In an embodiment, the work distribution unit 514 manages a pending task pool and an active task pool for each of the general processing cluster 520 modules. The pending task pool may comprise a number of slots (e.g., 32 slots) that contain tasks assigned to be processed by a particular general processing cluster 520. The active task pool may comprise a number of slots (e.g., 4 slots) for tasks that are actively being processed by the general processing cluster 520 modules. As a general processing cluster 520 finishes the execution of a task, that task is evicted from the active task pool for the general processing cluster 520 and one of the other tasks from the pending task pool is selected and scheduled for execution on the general processing cluster 520. If an active task has been idle on the general processing cluster 520, such as while waiting for a data dependency to be resolved, then the active task may be evicted from the general processing cluster 520 and returned to the pending task pool while another task in the pending task pool is selected and scheduled for execution on the general processing cluster 520.

The work distribution unit 514 communicates with the one or more general processing cluster 520 modules via crossbar 518. The crossbar 518 is an interconnect network that couples many of the units of the parallel processing unit 506 to other units of the parallel processing unit 506. For example, the crossbar 518 may be configured to couple the work distribution unit 514 to a particular general processing cluster 520. Although not shown explicitly, one or more other units of the parallel processing unit 506 may also be connected to the crossbar 518 via the hub 516.

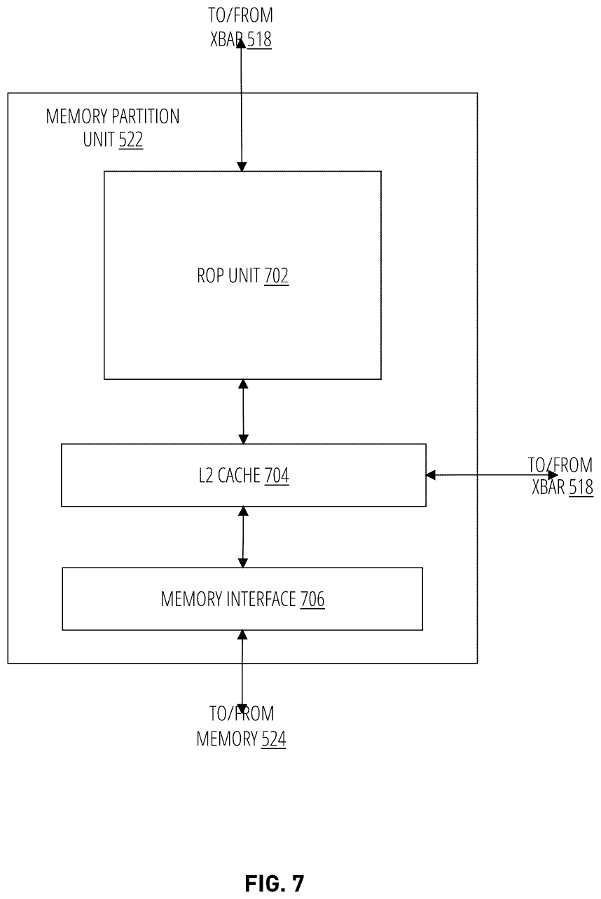

The tasks are managed by the scheduler unit 512 and dispatched to a general processing cluster 520 by the work distribution unit 514. The general processing cluster 520 is configured to process the task and generate results. The results may be consumed by other tasks within the general processing cluster 520, routed to a different general processing cluster 520 via the crossbar 518, or stored in the memory 524. The results can be written to the memory 524 via the memory partition unit 522 modules, which implement a memory interface for reading and writing data to/from the memory 524. The results can be transmitted to another parallel processing unit 506 or CPU via the NVLink 504. In an embodiment, the parallel processing unit 506 includes a number U of memory partition unit 522 modules that is equal to the number of separate and distinct memory 524 devices coupled to the parallel processing unit 506. A memory partition unit 522 will be described in more detail below in conjunction with FIG. 7.

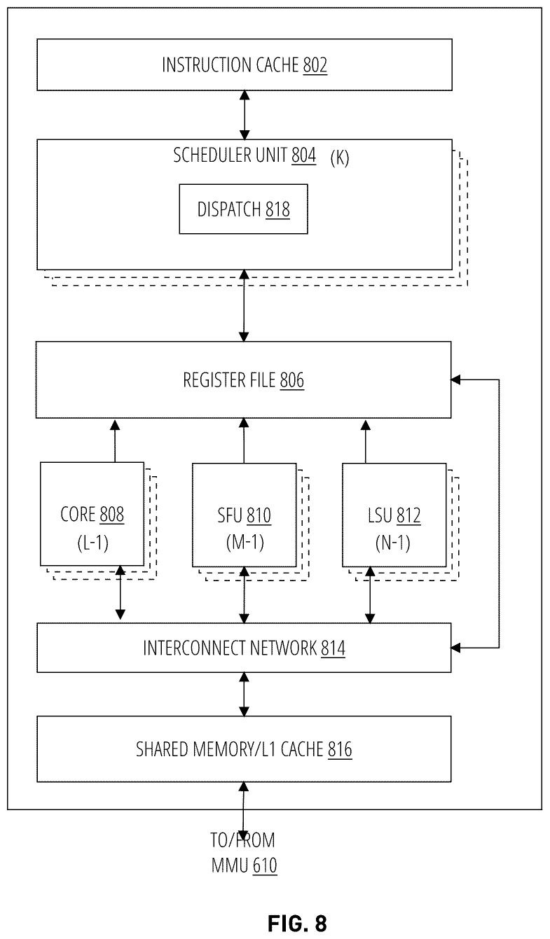

In an embodiment, a host processor executes a driver kernel that implements an application programming interface (API) that enables one or more applications executing on the host processor to schedule operations for execution on the parallel processing unit 506. In an embodiment, multiple compute applications are simultaneously executed by the parallel processing unit 506 and the parallel processing unit 506 provides isolation, quality of service (QoS), and independent address spaces for the multiple compute applications. An application may generate instructions (e.g., API calls) that cause the driver kernel to generate one or more tasks for execution by the parallel processing unit 506. The driver kernel outputs tasks to one or more streams being processed by the parallel processing unit 506. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 8.

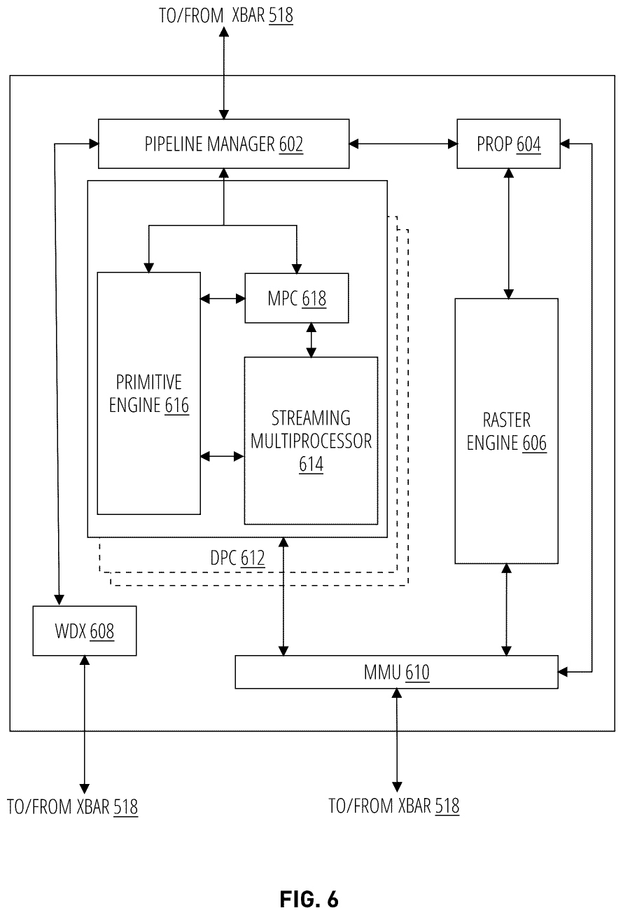

FIG. 6 depicts a general processing cluster 520 of the parallel processing unit 506 of FIG. 5, in accordance with an embodiment. As shown in FIG. 6, each general processing cluster 520 includes a number of hardware units for processing tasks. In an embodiment, each general processing cluster 520 includes a pipeline manager 602, a pre-raster operations unit 604, a raster engine 606, a work distribution crossbar 608, a memory management unit 610, and one or more data processing cluster 612. It will be appreciated that the general processing cluster 520 of FIG. 6 may include other hardware units in lieu of or in addition to the units shown in FIG. 6.

In an embodiment, the operation of the general processing cluster 520 is controlled by the pipeline manager 602. The pipeline manager 602 manages the configuration of the one or more data processing cluster 612 modules for processing tasks allocated to the general processing cluster 520. In an embodiment, the pipeline manager 602 may configure at least one of the one or more data processing cluster 612 modules to implement at least a portion of a graphics rendering pipeline. For example, a data processing cluster 612 may be configured to execute a vertex shader program on the programmable streaming multiprocessor 614. The pipeline manager 602 may also be configured to route packets received from the work distribution unit 514 to the appropriate logical units within the general processing cluster 520. For example, some packets may be routed to fixed function hardware units in the pre-raster operations unit 604 and/or raster engine 606 while other packets may be routed to the data processing cluster 612 modules for processing by the primitive engine 616 or the streaming multiprocessor 614. In an embodiment, the pipeline manager 602 may configure at least one of the one or more data processing cluster 612 modules to implement a neural network model and/or a computing pipeline.

The pre-raster operations unit 604 is configured to route data generated by the raster engine 606 and the data processing cluster 612 modules to a Raster Operations (ROP) unit, described in more detail in conjunction with FIG. 7. The pre-raster operations unit 604 may also be configured to perform optimizations for color blending, organize pixel data, perform address translations, and the like.

The raster engine 606 includes a number of fixed function hardware units configured to perform various raster operations. In an embodiment, the raster engine 606 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 606 comprises fragments to be processed, for example, by a fragment shader implemented within a data processing cluster 612.

Each data processing cluster 612 included in the general processing cluster 520 includes an M-pipe controller 618, a primitive engine 616, and one or more streaming multiprocessor 614 modules. The M-pipe controller 618 controls the operation of the data processing cluster 612, routing packets received from the pipeline manager 602 to the appropriate units in the data processing cluster 612. For example, packets associated with a vertex may be routed to the primitive engine 616, which is configured to fetch vertex attributes associated with the vertex from the memory 524. In contrast, packets associated with a shader program may be transmitted to the streaming multiprocessor 614.

The streaming multiprocessor 614 comprises a programmable streaming processor that is configured to process tasks represented by a number of threads. Each streaming multiprocessor 614 is multi-threaded and configured to execute a plurality of threads (e.g., 32 threads) from a particular group of threads concurrently. In an embodiment, the streaming multiprocessor 614 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 614 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 614 will be described in more detail below in conjunction with FIG. 8.

The memory management unit 610 provides an interface between the general processing cluster 520 and the memory partition unit 522. The memory management unit 610 may provide translation of virtual addresses into physical addresses, memory protection, and arbitration of memory requests. In an embodiment, the memory management unit 610 provides one or more translation lookaside buffers (TLBs) for performing translation of virtual addresses into physical addresses in the memory 524.

FIG. 7 depicts a memory partition unit 522 of the parallel processing unit 506 of FIG. 5, in accordance with an embodiment. As shown in FIG. 7, the memory partition unit 522 includes a raster operations unit 702, a level two cache 704, and a memory interface 706. The memory interface 706 is coupled to the memory 524. Memory interface 706 may implement 32, 64, 128, 1024-bit data buses, or the like, for high-speed data transfer. In an embodiment, the parallel processing unit 506 incorporates U memory interface 706 modules, one memory interface 706 per pair of memory partition unit 522 modules, where each pair of memory partition unit 522 modules is connected to a corresponding memory 524 device. For example, parallel processing unit 506 may be connected to up to Y memory 524 devices, such as high bandwidth memory stacks or graphics double-data-rate, version 5, synchronous dynamic random access memory, or other types of persistent storage.

In an embodiment, the memory interface 706 implements an HBM2 memory interface and Y equals half U. In an embodiment, the HBM2 memory stacks are located on the same physical package as the parallel processing unit 506, providing substantial power and area savings compared with conventional GDDR5 SDRAM systems. In an embodiment, each HBM2 stack includes four memory dies and Y equals 4, with HBM 2 stack including two 128-bit channels per die for a total of 8 channels and a data bus width of 1024 bits.

In an embodiment, the memory 524 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 506 modules process very large datasets and/or run applications for extended periods.

In an embodiment, the parallel processing unit 506 implements a multi-level memory hierarchy. In an embodiment, the memory partition unit 522 supports a unified memory to provide a single unified virtual address space for CPU and parallel processing unit 506 memory, enabling data sharing between virtual memory systems. In an embodiment the frequency of accesses by a parallel processing unit 506 to memory located on other processors is traced to ensure that memory pages are moved to the physical memory of the parallel processing unit 506 that is accessing the pages more frequently. In an embodiment, the NVLink 504 supports address translation services allowing the parallel processing unit 506 to directly access a CPU's page tables and providing full access to CPU memory by the parallel processing unit 506.

In an embodiment, copy engines transfer data between multiple parallel processing unit 506 modules or between parallel processing unit 506 modules and CPUs. The copy engines can generate page faults for addresses that are not mapped into the page tables. The memory partition unit 522 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 524 or other system memory may be fetched by the memory partition unit 522 and stored in the level two cache 704, which is located on-chip and is shared between the various general processing cluster 520 modules. As shown, each memory partition unit 522 includes a portion of the level two cache 704 associated with a corresponding memory 524 device. Lower level caches may then be implemented in various units within the general processing cluster 520 modules. For example, each of the streaming multiprocessor 614 modules may implement an L1 cache. The L1 cache is private memory that is dedicated to a particular streaming multiprocessor 614. Data from the level two cache 704 may be fetched and stored in each of the L1 caches for processing in the functional units of the streaming multiprocessor 614 modules. The level two cache 704 is coupled to the memory interface 706 and the crossbar 518.

The raster operations unit 702 performs graphics raster operations related to pixel color, such as color compression, pixel blending, and the like. The raster operations unit 702 also implements depth testing in conjunction with the raster engine 606, receiving a depth for a sample location associated with a pixel fragment from the culling engine of the raster engine 606. The depth is tested against a corresponding depth in a depth buffer for a sample location associated with the fragment. If the fragment passes the depth test for the sample location, then the raster operations unit 702 updates the depth buffer and transmits a result of the depth test to the raster engine 606. It will be appreciated that the number of partition memory partition unit 522 modules may be different than the number of general processing cluster 520 modules and, therefore, each raster operations unit 702 may be coupled to each of the general processing cluster 520 modules. The raster operations unit 702 tracks packets received from the different general processing cluster 520 modules and determines which general processing cluster 1 that a result generated by the raster operations unit 702 is routed to through the crossbar 518. Although the raster operations unit 702 is included within the memory partition unit 522 in FIG. 7, in other embodiment, the raster operations unit 702 may be outside of the memory partition unit 522. For example, the raster operations unit 702 may reside in the general processing cluster 520 or another unit.

FIG. 8 illustrates the streaming multiprocessor 614 of FIG. 6, in accordance with an embodiment. As shown in FIG. 8, the streaming multiprocessor 614 includes an instruction cache 802, one or more scheduler unit 804 modules (e.g., such as scheduler unit 512), a register file 806, one or more processing core 808 modules, one or more special function unit 810 modules, one or more load/store unit 812 modules, an interconnect network 814, and a shared memory/L1 cache 816.

As described above, the work distribution unit 514 dispatches tasks for execution on the general processing cluster 520 modules of the parallel processing unit 506. The tasks are allocated to a particular data processing cluster 612 within a general processing cluster 520 and, if the task is associated with a shader program, the task may be allocated to a streaming multiprocessor 614. The scheduler unit 512 receives the tasks from the work distribution unit 514 and manages instruction scheduling for one or more thread blocks assigned to the streaming multiprocessor 614. The scheduler unit 804 schedules thread blocks for execution as warps of parallel threads, where each thread block is allocated at least one warp. In an embodiment, each warp executes 32 threads. The scheduler unit 804 may manage a plurality of different thread blocks, allocating the warps to the different thread blocks and then dispatching instructions from the plurality of different cooperative groups to the various functional units (e.g., core 808 modules, special function unit 810 modules, and load/store unit 812 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads() function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 818 unit is configured within the scheduler unit 804 to transmit instructions to one or more of the functional units. In one embodiment, the scheduler unit 804 includes two dispatch 818 units that enable two different instructions from the same warp to be dispatched during each clock cycle. In alternative embodiments, each scheduler unit 804 may include a single dispatch 818 unit or additional dispatch 818 units.

Each streaming multiprocessor 614 includes a register file 806 that provides a set of registers for the functional units of the streaming multiprocessor 614. In an embodiment, the register file 806 is divided between each of the functional units such that each functional unit is allocated a dedicated portion of the register file 806. In another embodiment, the register file 806 is divided between the different warps being executed by the streaming multiprocessor 614. The register file 806 provides temporary storage for operands connected to the data paths of the functional units.

Each streaming multiprocessor 614 comprises L processing core 808 modules. In an embodiment, the streaming multiprocessor 614 includes a large number (e.g., 128, etc.) of distinct processing core 808 modules. Each core 808 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 808 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 808 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 614 also comprises M special function unit 810 modules that perform special functions (e.g., attribute evaluation, reciprocal square root, and the like). In an embodiment, the special function unit 810 modules may include a tree traversal unit configured to traverse a hierarchical tree data structure. In an embodiment, the special function unit 810 modules may include texture unit configured to perform texture map filtering operations. In an embodiment, the texture units are configured to load texture maps (e.g., a 2D array of texels) from the memory 524 and sample the texture maps to produce sampled texture values for use in shader programs executed by the streaming multiprocessor 614. In an embodiment, the texture maps are stored in the shared memory/L1 cache 816. The texture units implement texture operations such as filtering operations using mip-maps (e.g., texture maps of varying levels of detail). In an embodiment, each streaming multiprocessor 614 includes two texture units.

Each streaming multiprocessor 614 also comprises N load/store unit 812 modules that implement load and store operations between the shared memory/L1 cache 816 and the register file 806. Each streaming multiprocessor 614 includes an interconnect network 814 that connects each of the functional units to the register file 806 and the load/store unit 812 to the register file 806 and shared memory/L1 cache 816. In an embodiment, the interconnect network 814 is a crossbar that can be configured to connect any of the functional units to any of the registers in the register file 806 and connect the load/store unit 812 modules to the register file 806 and memory locations in shared memory/L1 cache 816.

The shared memory/L1 cache 816 is an array of on-chip memory that allows for data storage and communication between the streaming multiprocessor 614 and the primitive engine 616 and between threads in the streaming multiprocessor 614. In an embodiment, the shared memory/L 1 cache 816 comprises 128KB of storage capacity and is in the path from the streaming multiprocessor 614 to the memory partition unit 522. The shared memory/L1 cache 816 can be used to cache reads and writes. One or more of the shared memory/L 1 cache 816, level two cache 704, and memory 524 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 816 enables the shared memory/L1 cache 816 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 514 assigns and distributes blocks of threads directly to the data processing cluster 612 modules. The threads in a block execute the same program, using a unique thread ID in the calculation to ensure each thread generates unique results, using the streaming multiprocessor 614 to execute the program and perform calculations, shared memory/L1 cache 816 to communicate between threads, and the load/store unit 812 to read and write global memory through the shared memory/L1 cache 816 and the memory partition unit 522. When configured for general purpose parallel computation, the streaming multiprocessor 614 can also write commands that the scheduler unit 512 can use to launch new work on the data processing cluster 612 modules.

The parallel processing unit 506 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 506 is embodied on a single semiconductor substrate. In another embodiment, the parallel processing unit 506 is included in a system-on-a-chip (SoC) along with one or more other devices such as additional parallel processing unit 506 modules, the memory 524, a reduced instruction set computer (RISC) CPU, a memory management unit (MMU), a digital-to-analog converter (DAC), and the like.

In an embodiment, the parallel processing unit 506 may be included on a graphics card that includes one or more memory devices. The graphics card may be configured to interface with a PCIe slot on a motherboard of a desktop computer. In yet another embodiment, the parallel processing unit 506 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 9 is a conceptual diagram of a processing system implemented using the parallel processing unit 506 of FIG. 5, in accordance with an embodiment. The processing system includes a central processing unit 902, an switch 904, and multiple parallel processing unit 506 modules each and respective memory 524 modules. The switch 904 is depicted with dashed lines, indicating that it is optional in some embodiments.

The NVLink 504 provides high-speed communication links between each of the parallel processing unit 506 modules. Although a particular number of NVLink 504 and interconnect 502 connections are illustrated in FIG. 9, the number of connections to each parallel processing unit 506 and the central processing unit 902 may vary. The switch 904 interfaces between the interconnect 502 and the central processing unit 902. The parallel processing unit 506 modules, memory 524 modules, and NVLink 504 connections may be situated on a single semiconductor platform to form a parallel processing module 906. In an embodiment, the switch 904 supports two or more protocols to interface between various different connections and/or links.

In another embodiment (not shown), the NVLink 504 provides one or more high-speed communication links between each of the parallel processing unit modules (parallel processing unit 506, parallel processing unit 506, parallel processing unit 506, and parallel processing unit 506) and the central processing unit 902 and the switch 904 (when present) interfaces between the interconnect 502 and each of the parallel processing unit modules. The parallel processing unit modules, memory 524 modules, and interconnect 502 may be situated on a single semiconductor platform to form a parallel processing module 906. In yet another embodiment (not shown), the interconnect 502 provides one or more communication links between each of the parallel processing unit modules and the central processing unit 902 and the switch 904 interfaces between each of the parallel processing unit modules using the NVLink 504 to provide one or more high-speed communication links between the parallel processing unit modules. In another embodiment (not shown), the NVLink 504 provides one or more high-speed communication links between the parallel processing unit modules and the central processing unit 902 through the switch 904. In yet another embodiment (not shown), the interconnect 502 provides one or more communication links between each of the parallel processing unit modules directly. One or more of the NVLink 504 high-speed communication links may be implemented as a physical NVLink interconnect or either an on-chip or on-die interconnect using the same protocol as the NVLink 504.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 906 may be implemented as a circuit board substrate and each of the parallel processing unit modules and/or memory 524 modules may be packaged devices. In an embodiment, the central processing unit 902, switch 904, and the parallel processing module 906 are situated on a single semiconductor platform.

In an embodiment, each parallel processing unit module includes six NVLink 504 interfaces (as shown in FIG. 9, five NVLink 504 interfaces are included for each parallel processing unit module). The NVLink 504 may be operated exclusively for PPU-to-PPU communication as shown in FIG. 9, or some combination of PPU-to-PPU and PPU-to-CPU, when the central processing unit 902 also includes one or more NVLink 504 interfaces.

In an embodiment, the NVLink 504 allows direct load/store/atomic access from the central processing unit 902 to each parallel processing unit module's memory 524. In an embodiment, the NVLink 504 supports coherency operations, allowing data read from the memory 524 modules to be stored in the cache hierarchy of the central processing unit 902, reducing cache access latency for the central processing unit 902. In an embodiment, the NVLink 504 includes support for Address Translation Services (ATS), enabling the parallel processing unit module to directly access page tables within the central processing unit 902. One or more of the NVLink 504 may also be configured to operate in a low-power mode.

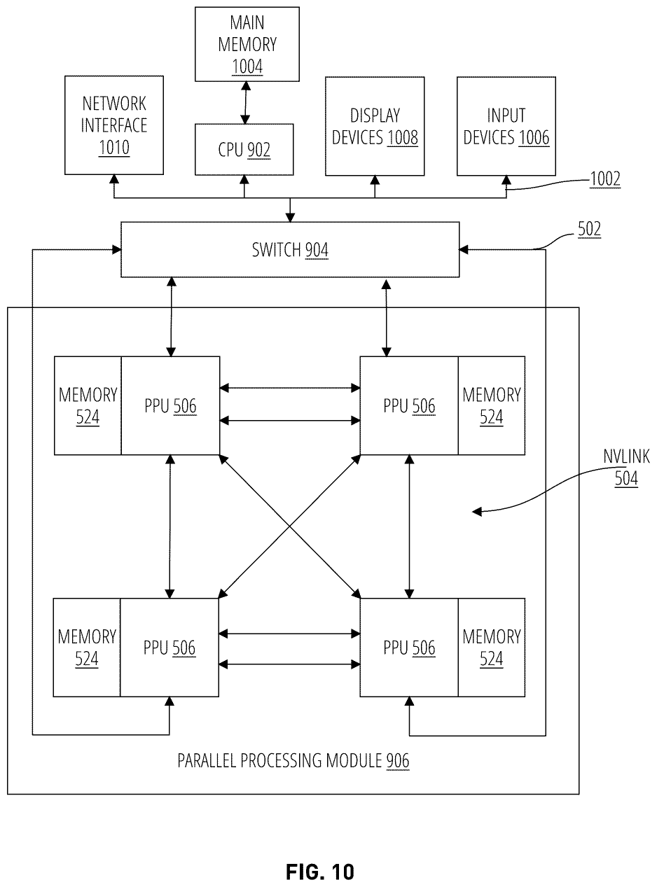

FIG. 10 depicts an exemplary processing system in which the various architecture and/or functionality of the various previous embodiments may be implemented. As shown, an exemplary processing system is provided including at least one central processing unit 902 that is connected to a communications bus 1002. The communication communications bus 1002 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1004. Control logic (software) and data are stored in the main memory 1004 which may take the form of random access memory (RAM). For simplicity of illustration, the main memory 1004 may be understood to comprise other forms of bulk memory, including non-volatile memory technologies.

The exemplary processing system also includes input devices 1006, the parallel processing module 906, and display devices 1008, e.g. a conventional CRT (cathode ray tube), LCD (liquid crystal display), LED (light emitting diode), plasma display or the like. User input may be received from the input devices 1006, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1010 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1004 and/or the secondary storage. Such computer programs, when executed, enable the exemplary processing system to perform various functions. The main memory 1004, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

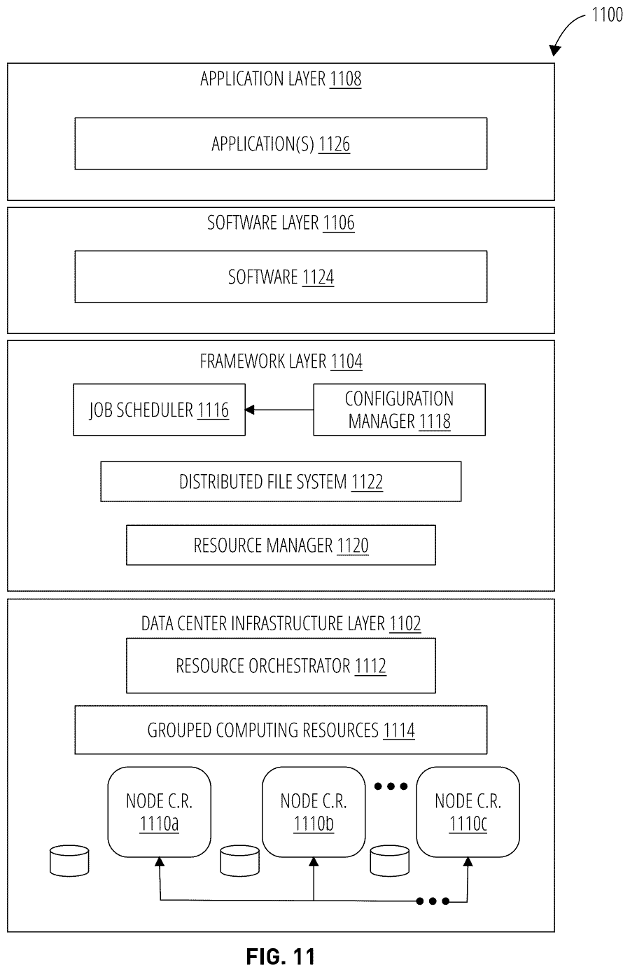

FIG. 11 depicts an exemplary data center 1100, in accordance with at least one embodiment. In at least one embodiment, data center 1100 includes, without limitation, a data center infrastructure layer 1102, a framework layer 1104, a software layer 1106, and an application layer 1108. The disclosed SBD link interfaces may be deployed between components of the data center infrastructure layer 1102, e.g., between chips or chip packages of the node computing resources 1110a, 1110b, 1110c.

In at least one embodiment, as depicted in FIG. 11, data center infrastructure layer 1102 may include a resource orchestrator 1112, grouped computing resources 1114, and node computing resources (node C.R. s) 1110a, 1110b, 1110c, where “N” represents any whole, positive integer. In at least one embodiment, node computing resources may include, but are not limited to, any number of central processing units (CPUs) or other processors (including accelerators, field programmable gate arrays (FPGAs), graphics processors, etc.), memory devices (e.g., dynamic read-only memory), storage devices (e.g., solid state or disk drives), network input/output (NW I/O) devices, network switches, virtual machines (VMs), power modules, and cooling modules, etc. In at least one embodiment, one or more node computing resources from among node computing resources 1110a, 1110b, 1110c may be a server having one or more of the above-mentioned computing resources.

In at least one embodiment, grouped computing resources 1114 may include separate groupings of node computing resources housed within one or more racks (not shown), or many racks housed in data centers at various geographical locations (also not shown). Separate groupings of node computing resources within grouped computing resources 1114 may include grouped compute network, memory, or storage resources that may be configured or allocated to support one or more workloads. In at least one embodiment, several node computing resources including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 1112 may configure or otherwise control one or more node computing resources 1110a, 1110b, 1110c and/or grouped computing resources 1114. In at least one embodiment, resource orchestrator 1112 may include a software design infrastructure (“SDI”) management entity for data center 1100. In at least one embodiment, resource orchestrator 1112 may include hardware, software, or some combination thereof.

In at least one embodiment, as depicted in FIG. 11, framework layer 1104 includes, without limitation, a job scheduler 1116, a configuration manager 1118, a resource manager 1120, and a distributed file system 1122. In at least one embodiment, framework layer 1104 may include a framework to support software 1124 of software layer 1106 and/or one or more application(s) 1126 of application layer 220. In at least one embodiment, software 1124 or application(s) 1126 may respectively include web-based service software or applications, such as those provided by Amazon Web Services, Google Cloud, and Microsoft Azure. In at least one embodiment, framework layer 1104 may be, but is not limited to, a type of free and open-source software web application framework such as Apache SPARK™ (hereinafter “Spark) that may utilize a distributed file system 1122 for large-scale data processing (e.g., “big data”). In at least one embodiment, job scheduler 1116 may include a Spark driver to facilitate scheduling of workloads supported by various layers of data center 1100. In at least one embodiment, configuration manager 1118 may be capable of configuring different layers such as software layer 1106 and framework layer 1104, including Spark and distributed file system 1122 for supporting large-scale data processing. In at least one embodiment, resource manager 1120 may be capable of managing clustered or grouped computing resources mapped to or allocated for support of distributed file system 1122 and job scheduler 1116. In at least one embodiment, clustered or grouped computing resources may include grouped computing resources 1114 at data center infrastructure layer 1102. In at least one embodiment, resource manager 1120 may coordinate with resource orchestrator 1112 to manage these mapped or allocated computing resources.

In at least one embodiment, software 1124 included in software layer 1106 may include software used by at least portions of node computing resources 1110a, 1110b, 1110c, grouped computing resources 1114, and/or distributed file system 1122 of framework layer 1104. One or more types of software may include, but are not limited to, Internet web page search software, e-mail virus scan software, database software, and streaming video content software.

In at least one embodiment, application(s) 1126 included in application layer 1108 may include one or more types of applications used by at least portions of node computing resources 1110a, 1110b, 1110c, grouped computing resources 1114, and/or distributed file system 1122 of framework layer 1104. In at least one or more types of applications may include, without limitation, Compute Unified Device Architecture (CUDA) applications, 5G network applications, artificial intelligence applications, data center applications, and/or variations thereof.

In at least one embodiment, any of configuration manager 1118, resource manager 1120, and resource orchestrator 1112 may implement any number and type of self-modifying actions based on any amount and type of data acquired in any technically feasible fashion. In at least one embodiment, self-modifying actions may relieve a data center operator of data center 1100 from making possibly bad configuration decisions and possibly avoiding underutilized and/or poorly performing portions of a data center.

### LISTING OF DRAWING ELEMENTS

102 transmitter
104 receiver
106 channel
108 hybrid circuit
110 eye diagrams
202 replica driver
204 transmit driver
206 trans-impedance amplifier
208 communication channel
210 resistive network
302a transmit driver
302b transmit driver
304a replica driver
304b replica driver
306a receiver
306b receiver
308a trimming transistor
308b trimming transistor
310 link
312a ESD protection circuit
312b ESD protection circuit
314 RC shunt
402 serializer
404 pre-driver stage
406 main transmit driver
408 replica driver
410 driver and hybrid stage
412 configurable delay
414 configurable delay
416 pass gate
418 tri-capacitance network
420 DC-restoring receiver front end
422 communication channel
424 deserializer
502 interconnect
504 NVLink
506 parallel processing unit
508 I/O unit
510 front-end unit
512 scheduler unit
514 work distribution unit
516 hub
518 crossbar
520 general processing cluster
522 memory partition unit
524 memory
602 pipeline manager
604 pre-raster operations unit
606 raster engine
608 work distribution crossbar
610 memory management unit
612 data processing cluster
614 streaming multiprocessor
616 primitive engine
618 M-pipe controller
702 raster operations unit
704 level two cache
706 memory interface
802 instruction cache
804 scheduler unit
806 register file
808 core
810 special function unit
812 load/store unit
814 interconnect network
816 shared memory/L1 cache
818 dispatch
902 central processing unit
904 switch
906 parallel processing module
1002 communications bus
1004 main memory
1006 input devices
1008 display devices
1010 network interface
1100 data center
1102 data center infrastructure layer
1104 framework layer
1106 software layer
1108 application layer
1110a node computing resource
1110b node computing resource
1110c node computing resource
1112 resource orchestrator
1114 grouped computing resources
1116 job scheduler
1118 configuration manager
1120 resource manager
1122 distributed file system
1124 software
1126 application(s)

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A simultaneous bi-directional (SBD) transceiver comprising:
a main transmit driver;
a replica transmit driver; and
a tri-capacitance network.

2. The SBD transceiver of claim 1, wherein the replica transmit driver is configured to receive an inverted form of a signal received by the main transmit driver.

3. The SBD transceiver of claim 1, wherein the SSB tri-impedance network comprises three discrete resistors.

4. The SBD transceiver of claim 1, wherein a ratio of sizes for the main transmit driver and the replica transmit driver is configured such that the tri-capacitance network distinguishes simultaneously transmitted and received signals at an input to a receiver.

5. The SBD transceiver of claim 4, wherein the receiver comprises a trans-impedance amplifier.

6. The SBD transceiver of claim 1, wherein the main transmit driver comprises trimming transistors.

7. The SBD transceiver of claim 1, wherein the replica transmit driver comprises trimming transistors.

8. The SBD transceiver of claim 1, further comprising:
a receiver;
an impedance configured to terminate a link; and
the impedance configured to set a time constant of the link to be at least an order of magnitude larger than a time constant of a feedback loop in the receiver.

9. The SBD transceiver of claim 8, wherein the impedance is a resistor.

10. The SBD transceiver of claim 8, wherein the impedance is provided by an electrostatic discharge circuit.

11. A simultaneous bi-directional (SBD) transceiver comprising:
a main transmit driver;
a replica transmit driver; and
a resistive-bi-capacitance network.

12. An SBD transceiver comprising:
a driver stage;
a pre-driver stage; and
wherein the pre-driver stage comprises parallel delay paths for a main transmit driver and a replica transmit driver, a delay of each of the delay paths being independently configurable; and
the driver stage comprising a tri-capacitance network.

13. The SBD transceiver of claim 12, wherein the delay path for the main transmit driver is configured to provide more precise tuning of signal delay than the delay path of the replica transmit driver.

14. The SBD transceiver of claim 12, wherein the replica transmit driver is configured to receive an inverted form of a signal received by the main transmit driver.

15. The SBD transceiver of claim 12, further comprising an RC circuit coupled to receive signals from the replica transmit driver and the tri-capacitance network.

16. The SBD transceiver of claim 12, wherein a ratio of sizes for the main transmit driver and the replica transmit driver is configured to facilitate subtraction of simultaneously transmitted and received signals.

17. The SBD transceiver of claim 16, further comprising a trans-impedance amplifier configured to receive signals from the tri-capacitance network.

18. The SBD transceiver of claim 12, further comprising trimming transistors coupled to the main transmit driver.

19. The SBD transceiver of claim 1, further comprising trimming transistors coupled to the replica transmit driver.

20. An SBD transceiver comprising:
a driver stage;
a pre-driver stage; and
wherein the pre-driver stage comprises parallel delay paths for a main transmit driver and a replica transmit driver, a delay of each of the delay paths being independently configurable; and
the driver stage comprising a resistive-bi-capacitance network.

21. A method of performing SBD communication, the method comprising:
communicating outbound signals to tri-capacitance network via a main transmit driver and a replica transmit driver; and
receiving inbound signals at an amplifier via the tri-capacitance network.

22. The method of claim 21, further comprising:
configuring the tri-capacitance network into one of a near-ground configuration or near-supply configuration for uni-directional communication.

23. The method of claim 21, further comprising:
trimming one or more of the main transmit driver and the replica transmit driver to account for channel loading.

24. The method of claim 21, further comprising:
independently tuning a delay for signals received by the main transmit driver and the replica transmit driver.
